(19) United States
(12) Patent Application Publication
(10) Pub. No.: US 2010/0063604 A1
(43) Pub. Date: Mar. 11, 2010

(54) Method for the Secure Transmission of Data of a Field Device used in Process Automation Technology

(75) Inventors: Markus Kilian, Freiburg (DE); Bernd Strutt, Steinen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 12/083,359

(22) PCT Filed: Sep. 14, 2006
(86) PCT No.: PCT/EP2006/066372

§ 371 Date: Jan. 26, 2009

(30) Foreign Application Priority Data
Oct. 11, 2005 (DE) 10 2005 048 996.6

(51) Int. Cl. G05B 9/02; H04L 12/40

(52) U.S. Cl. 700/79; 370/241

(57) ABSTRACT

In a method for safe transmission of data of a field device of process automation technology via a fieldbus, the transmission signal is registered as a check signal in the field device during the transmission. Analysis of the check signal, on the basis of data content or signal form, detects whether the desired data were transmitted properly.

The invention relates to a method for safe transmission of data of a field device of process automation technology.

In process automation technology, field devices are often applied for registering and/or influencing process variables. Examples of such field devices include fill level measuring devices, mass flow measuring devices, pressure- and temperature-measuring devices, pH and conductivity measuring devices, etc., which, as sensors, register the corresponding process variables, fill-level, flow, pressure, temperature, pH-value and conductivity value.

Serving for influencing process variables are field devices in the form of actuators, which e.g., as valves, control the flow of a liquid in a pipeline section, or, as pumps, the fill-level in a container.

Also referred to as field devices are logging devices, which record measurement data on-site.

A large number of such field devices are manufactured and sold by the firm, Endress+Hauser.

As a rule, field devices in modern automated plants are connected via fieldbus systems (HART, Profibus, Foundation Fieldbus, etc.) with superordinated units (e.g. control systems or control units). These units serve, among other things, for process control, process visualizing, process monitoring.

Most often, the fieldbus systems are integrated in enterprise networks. Therewith, process, or field device, data can be accessed from various areas of an enterprise.

For worldwide communication, company networks can also be connected with public networks, e.g. the Internet.

In the communication of a field device with a superordinated unit, data to be transmitted data are produced in an application program of the field device.

The data can be measured values, alarm reports, etc.

In a communication-controller, data to be transmitted data are packaged in fieldbus telegrams, which are specified according to the fieldbus being used. In a transfer unit (Medium Access Unit MAU), the fieldbus telegrams are then converted into transmission signals meeting the physical requirements of the fieldbus.

Especially in the case of safety-critical applications, a safe and reliable data transmission is a necessity.

In the case of conventional field devices, it is, however, not checked, whether data produced in the device are, in fact, really transmitted via the fieldbus as transmission signals from the transfer unit.

For instance, an alarm report can either be transmitted not at all or not in accordance with the fieldbus specifications, so that either it does not arrive at the receiver or else it arrives at, but cannot be read by, the receiver.

The application program assumes, however, that the telegram with the alarm report was correctly transferred and received by the receiver. It has, therefore, no impetus to transmit, yet again, the telegram of concern.

An object of the invention is, therefore, to provide a method for safe transmission of data of a field device of process automation technology via a fieldbus, wherein the method does not have the above-mentioned disadvantages and, especially, detects errors in the data transmission.

This object is achieved by the method features defined in claim 1.

Advantageous further developments of the invention are presented in the dependent claims.

An essential idea of the invention is, during transmission, to read the fieldbus telegram back into the field device as a check signal, which is then checked in the field device.

In this check, it can be detected, whether the fieldbus telegram was correctly sent.

There are, in principle, two different analysis variants available—first, as regards the data content and, second, as regards the signal form.

Thus, in the first case, the data values contained in the check signal are compared with the data values, which were provided for transmission. In this way, errors during the packaging of the data in fieldbus telegrams or in the signal production in the transfer unit can be detected and eliminated.

In the second case, the check signal is analyzed as regards its physical properties and compared with standard values.

Thus, it is assured, that the sent signal fulfills particular requirements of the fieldbus specification as regards signal form.

If these requirements are not fulfilled, then, by an appropriate readjustment, the transmission signal can be made suitable.

In this way, it can be assured, that the fieldbus telegram has been transmitted as a “clean” signal meeting the fieldbus specification. Thus, the signal must, in principle, then also be receivable and readable at the receiver.

In case error arises in the production of the physical signal or during packaging of the data, and such is detected, a corresponding error report is produced and transmitted, e.g. to the control system.

According to the invention, two transfer units of identical construction are provided in the field device.

In a simpler embodiment of the invention, only a single transfer unit is provided.

The invention will now be explained in greater detail on the basis of an example of an embodiment illustrated in the drawing, the figures of which show as follows:

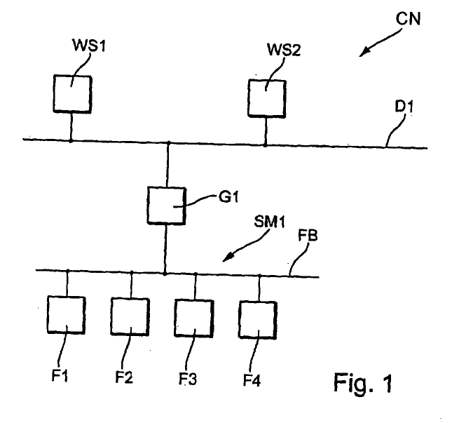

FIG. 1 a schematic illustration of a network of automation technology;

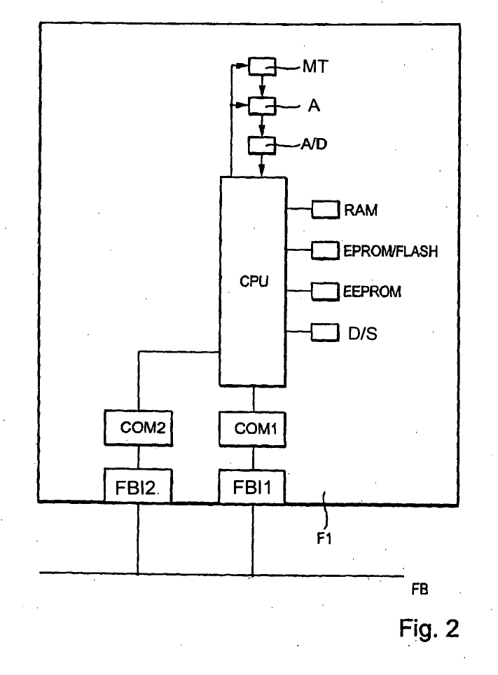

FIG. 2 a block diagram of a field device of the invention; and

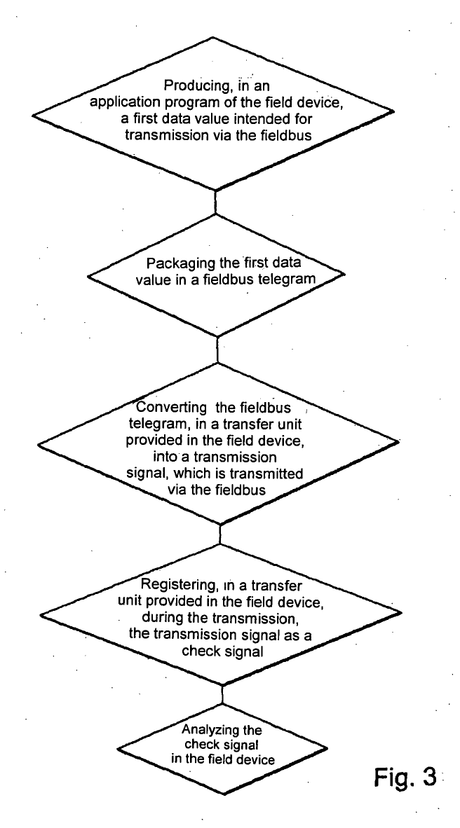

FIG. 3 a flow diagram of individual method steps of the method of the invention.

FIG. 1 shows a network of automation technology, or a communication network, CN. Connected to a data bus D1 are a plurality of computer units in the form of small workstations WS1, WS2. These computer units serve as superordinated units (control systems or control units) for, among other things, process visualizing, process monitoring and for engineering, as well as for servicing and monitoring field devices. Data bus D1 works e.g. according to the Profibus DP-standard or the HSE (High Speed Ethernet) standard of Foundation fieldbus.

Data bus D1 is connected with a fieldbus-segment SM1 via a gateway G1, which is also referred to as a linking device or a segment-coupler. Fieldbus-segment SM1 is composed of a plurality of field devices F1, F2, F3, F4, which are connected with one another via a fieldbus FB. The field devices F1, F2, F3, F4 can be sensors or actuators. Fieldbus FB works according to one of the known fieldbus standards, Profibus, Foundation fieldbus or HART.

FIG. 2 shows, in greater detail, a block diagram of a field device of the invention, e.g. field device F1. A microprocessor μP is connected for measured-value processing, via an analog-digital converter A/D and an amplifier A, with a measuring transducer MT, which registers a process variable (e.g. pressure, flow or fill level). The microprocessor μP operates in conjunction with a plurality of memories. Memory VM serves as temporary (volatile), working memory RAM. A further memory, EPROM, or flash-memory, FLASH, serves as memory for the application program to be executed in the microprocessor μP. In a non-volatile, writable data memory NVM, e.g. EEPROM memory, parameter values (e.g. calibration data, etc.) are stored.

The application program executed in the microprocessor μP defines the particular functionalities of the field device (measured value calculation, envelope curve evaluation, linearizing of measured values, diagnostic tasks, etc.).

Additionally, the microprocessor μP is connected with a display/service unit D/S (e.g. an LCD-display having a plurality of pushbuttons).

For communication with the fieldbus-segment SM1, the microprocessor μP is connected via a communication-controller COM1 with a fieldbus interface FBI1, which is also referred to as a transfer unit or an MAU (Medium Attach Unit). A power supply PS delivers the needed energy for the individual electronic components of the field device F1. The power supply can be fed by the fieldbus FB or by another energy source. The supply lines for energy supply to the individual components in the field device are not drawn in, in order to avoid clutter in the drawing.

Going beyond a conventional field device, in the field device F1 of the invention, a second communication-controller COM2 and a second fieldbus interface FBI2 are provided, the latter likewise being connected with the fieldbus FB.

The method of the invention will now be explained in greater detail on the basis of FIG. 3.

In a first method step a, a data value is produced in the application program running in the microcontroller μP of the field device.

This data value can be a measured value or an alarm report.

For transmission via the fieldbus FB, the data value must be packaged in a fieldbus telegram (method step b). The fieldbus telegram is composed e.g. of a start delimiter, address field, control bits, the actual data field with the data value, test bits and end delimiter.

In the fieldbus interface FBI1, the fieldbus telegram is converted into a transmission signal, which conforms, or should conform, to the physical specifications of the pertinent fieldbus standard (method step c).

The transmission signal is registered during transmission as a check signal (method step d). This can be done with the second fieldbus interface FBI2 and the second communication controller COM2. Alternatively, the check signal can be registered with the fieldbus interface FBI1 and the communication-controller COM1, with, then, the two components FBI2 and COM2 being omitted.

Finally, an analysis of the check signal is performed in the field device (method step e).

The check signal can be analyzed as regards its signal form or its data content, for the purpose of checking for error.

According to claim 2, the check signal is converted in the fieldbus interface FBI2 back into a fieldbus telegram and fed to the communication-controller COM2, where the data content of the telegram is read out as a second data value.

Then, the actually sent data value, the second data value, is compared with the data value, which was provided by the application program for transmission, the first data value.

In this way, it can be checked, whether the first data value was properly transmitted via the fieldbus.

If the two data values do not agree with one another, then a malfunction is present. Especially, in the case of alarm values, it must be assured, that these also correctly arrive at the receiver.

Alternatively, the signal form of the check signal can be analyzed. To this end, values for typical signal forms corresponding to the fieldbus specifications are stored in the field device.

In the case of this analysis, signal drifts can be detected and suitable countermeasures introduced. Frequency, in the case of a HART-transmission, can be readjusted, in order that the frequency lies in the specified region of 1200 Hz±12 Hz, or 2200 Hz±22 Hz (HART Physical Layer Specification Rev. 8.1), as the case may be.

Likewise, in the case of a bus system such as e.g. Profibus or Foundation fieldbus, the bit time of 32 microsec±0.9 microsec can be adjusted. In this way, likewise, a safe data transmission is assured. Since the values for typical signal forms of fieldbus telegrams are stored in the field device, also bus systems of different kind can be automatically recognized by the field device. The values of the fieldbus telegrams transmitted via the fieldbus are determined and compared with the stored values. Bus systems with the same bus physics can, however, not be distinguished.

Since, with the method of the invention, among other things, also the signal form of the check signal can be analyzed, also signals of other field devices can be tested, whether these lie within corresponding tolerances of the fieldbus specifications, and, in case not, an appropriate report can be produced, in order to signal the error or in order to be able to introduce countermeasures.

In a simpler embodiment of the invention, the sending and simultaneous reading of the telegram to be transmitted is accomplished with the same fieldbus parts, i.e. the field device has only one fieldbus interface FBI. If conditions require, also the second communication-controller can be omitted, so that one communication-controller COM is sufficient.

This embodiment of the invention is, indeed, cost-favorable; however, it has some disadvantages. Thus, errors of signals, which depend on a reference signal, or a reference element, in the communication-controller COM or in the fieldbus interface, cannot be detected. For instance, a changing of the oscillator frequency remains unrecognized, because no second oscillator frequency is available. The same is true also for other components, such as a reference diode, etc.

Other options include a variant with one fieldbus interface and two communication-controllers. In this way, the disadvantages mentioned in the preceding paragraph are lessened.

If the data content of the check signal is incorrect, such could have been caused by a disturbing in-coupling. Opportunity for such in-coupling is presented e.g. by the ultrasonic pulses of an ultrasonic travel-time measuring device or the start pulses of electric motors.

As a rule, in-couplings occur statistically uncorrelated, so that malfunctions are detected rather seldomly, and, if at all, then accidentally.

Regular disturbances can indicate in-coupling correlated to events (e.g. the ultrasonic pulse) occurring in the field device of interest, or in other field devices. An opportunity for lessening the influence of such in-coupling is targeted shifting (e.g. delaying) of the transmission point in time. Such shifting can be performed automatically by the field device. In this way, the data transmission is made safer.

Through the invention, an essentially safe transmission of data via a fieldbus is assured. This is important especially for safety-critical applications, which must satisfy strict specifications and constraints, such as e.g. IEC 61508 SIL 3.

1-8. (canceled)

9. A method for safe transmission of data of a field device of process automation technology via a fieldbus, comprising the steps:
producing, in an application program of the field device, a first data value intended for transmission via the fieldbus;
packaging the first data value in a fieldbus telegram;
converting the fieldbus telegram, in a transfer unit provided in the field device, into a transmission signal, which is transmitted via the fieldbus;
registering, in a transfer unit provided in the field device, during the transmission, the transmission signal as a check signal; and
analyzing the check signal in the field device.

10. The method as claimed in claim 9, wherein said analyzing of the check signal includes the further steps of:
converting the check signal into a fieldbus telegram;
reading-out a second data value packaged in the fieldbus telegram; and comparing the first data value with the actually sent, second data value.

11. The method as claimed in claim 9, wherein said analyzing of the check signal includes the additional steps of:
registering at least one value of a physical property of the check signal; and comparing the registered value with an allowed value.

12. The method as claimed in claim 9 wherein:
in case deviations or errors are found in the analyzing of the check signal, an error report is produced.

13. The method as claimed in claim 9, wherein:
in case deviations are found in the analyzing of the physical properties of the check signal, a modification of the transmission signals occurs, in order to lessen the deviations.

14. The method as claimed in claim 9, wherein:
one transfer unit is provided in the field device.

15. The method as claimed in claims 9, wherein:
two separate transfer units FBI1, FBI2 are provided in the field device.

16. An apparatus for performing a method as claimed in claim 9.
